(19) United States
(12) Patent Application Publication
(10) Pub. No.: US 2025/0252777 A1
(43) Pub. Date: Aug. 7, 2025

(54) METHOD OF ESTABLISHING TARGET MODEL TO BE USED TO IDENTIFY SPECIFIC TYPE OF FACIAL TEXTURE

(71) Applicant: Shanghai Baiyu Technology Co., Ltd., Shanghai City (CN)

(72) Inventors: Lung-Chi LEE, Kaohsiung City (TW); Lung-I LEE, Kaohsiung City (TW); Chi-Min WU, Kaohsiung City (TW)

(21) Appl. No.: 19/036,411

(22) Filed: Jan. 24, 2025

(30) Foreign Application Priority Data
Feb. 1, 2024 (CN) 202410148946.6

(51) Int. Cl. G06V 40/16; G06V 10/77; G06V 10/776; G06V 10/82

(52) U.S. Cl. CPC G06V 40/172; G06V 10/7715; G06V 10/776; G06V 10/82

(57) ABSTRACT

A method includes: A) performing feature extraction on training images to obtain post-extraction images; B) performing transformation on the post-extraction images to obtain post-transformation images; C) performing feature identification on the post-transformation images to obtain post-identification images, each of the post-identification images having an identified mark indicating a specific type of facial texture; D) performing evaluation based on the post-identification images and ground truth images to obtain a loss value; E) determining whether the loss value is less than a preset threshold; F) in response to determining that the loss value is not less than the preset threshold, adjusting parameters of a neural network model, and repeating steps A) to E) by using the neural network model, the parameters of which have been adjusted; and G) in response to determining that the loss value is less than the preset threshold, designating the neural network model as a target model.

### CROSS-REFERENCE TO RELATED APPLICATION

This application claims priority to Chinese Invention Patent Application No. 202410148946.6, filed on Feb. 1, 2024, the entire disclosure of which is incorporated by reference herein.

### FIELD

The disclosure relates to a method of establishing a target model adapted to be used to identify a specific type of facial texture in a to-be-identified facial image.

### BACKGROUND

Identifying a type of facial texture (e.g., under-eye bags, tear stains, atrophic acne scars, wrinkles, etc.) in a to-be-identified facial image is important for many applications (e.g., in development of photo-retouching software). Conventional approaches to identifying a type of facial texture include feature extraction based on texture (which may involve use of the Hessian filter, the Frangi filter or the Gabor filter), feature extraction based on edge-detection operators (which may involve use of the Canny operator, the Laplace operator, or the difference of Gaussians, DoG, filter), and scanning by using three-dimensional scanners. However, for feature extraction based on texture, manual design of a filter is required (i.e., parameters of the filter require being repeatedly tuned for performance optimization), thereby complicating implementation of such approach. For feature extraction based on edge-detection operators, edge detection relies on the difference between grayscale values of immediately adjacent pixels, rather than a location of a line or a fold caused by a type of facial texture (e.g., a wrinkle) on facial skin, so such approach may be inappropriate for a type of facial texture that is large or wide. For scanning by using three-dimensional scanners, a three-dimensional scanner with great precision is needed, and thus hardware cost may be high.

### SUMMARY

Therefore, an object of the disclosure is to provide a method of establishing a target model adapted to be used to identify a specific type of facial texture in a to-be-identified facial image that can alleviate at least one of the drawbacks of the prior art.

According to the disclosure, the method is to be implemented by a computing device. The computing device stores plural entries of training data and a neural network model. Each of the entries of training data includes a training image that has the specific type of facial texture, and a ground truth image that is related to the training image and that has a pre-labeled mark indicating the specific type of facial texture. The neural network model includes an encoder and a decoder. The encoder includes a feature extraction layer and a vision transformer (ViT). The decoder includes plural upsampling blocks. The method includes steps of:
A) using the feature extraction layer of the encoder of the neural network model to perform feature extraction on the training images respectively of the entries of training data to obtain plural post-extraction images that correspond respectively to the entries of training data;
B) using the ViT of the encoder of the neural network model to perform transformation on the post-extraction images to obtain plural post-transformation images that correspond respectively to the post-extraction images;
C) using the upsampling blocks of the decoder of the neural network model to perform feature identification on the post-transformation images to obtain plural post-identification images that correspond respectively to the post-transformation images, each of the post-identification images having an identified mark indicating the specific type of facial texture;
D) using an algorithm of loss function to perform evaluation based on the post-identification images and the ground truth images respectively of the entries of training data to obtain a loss value;
E) determining whether the loss value is less than a preset threshold;
F) in response to determining that the loss value is not less than the preset threshold, adjusting plural parameters of the neural network model, and repeating steps A) to E) by using the neural network model, the parameters of which have been adjusted; and
G) in response to determining that the loss value is less than the preset threshold, designating the neural network model as the target model.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computing device according to an embodiment of the disclosure.

FIG. 2 is a block diagram illustrating a neural network model stored in the computing device according to an embodiment of the disclosure.

FIG. 3 is a flow chart illustrating a data preparation procedure according to an embodiment of the disclosure.

FIGS. 4 to 7 are flow charts cooperatively illustrating a model-establishing procedure according to an embodiment of the disclosure.

FIG. 8 is a flow chart illustrating details about a step of performing feature identification in the model-establishing procedure according to a variant of the embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

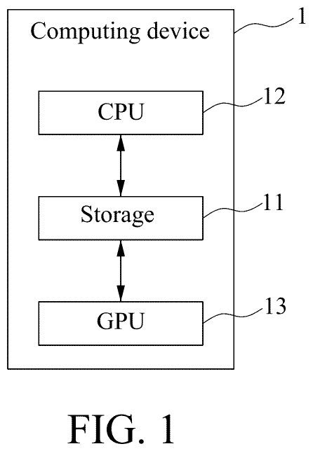

Referring to FIG. 1, an embodiment of a computing device 1 according to the disclosure is illustrated. The computing device 1 includes a storage 11, a central processing unit (CPU) 12 and a graphics processing unit (GPU) 13. Each of the CPU 12 and the GPU 13 is electrically connected to the storage 11. It should be noted that in some embodiments, the CPU 12 and the GPU 13 may be included respectively on two separate computing devices, i.e., one of the two separate computing devices includes the CPU 12, and the other of the two separate computing devices includes the GPU 13. Each of the two separate computing devices may include a storage that belongs to said each of the two separate computing devices and that is electrically connected to the corresponding one of the CPU 12 and the GPU 13.

The storage 11 stores plural entries of training data and a neural network model. The neural network model is adapted to be used to identify a specific type of facial texture (e.g., an under-eye bag, a tear stain, an atrophic acne scar, a wrinkle, etc.) in a to-be-identified facial image.

Each of the entries of training data includes a training image that has the specific type of facial texture, and a ground truth image that is related to the training image and that has a pre-labeled mark indicating the specific type of facial texture.

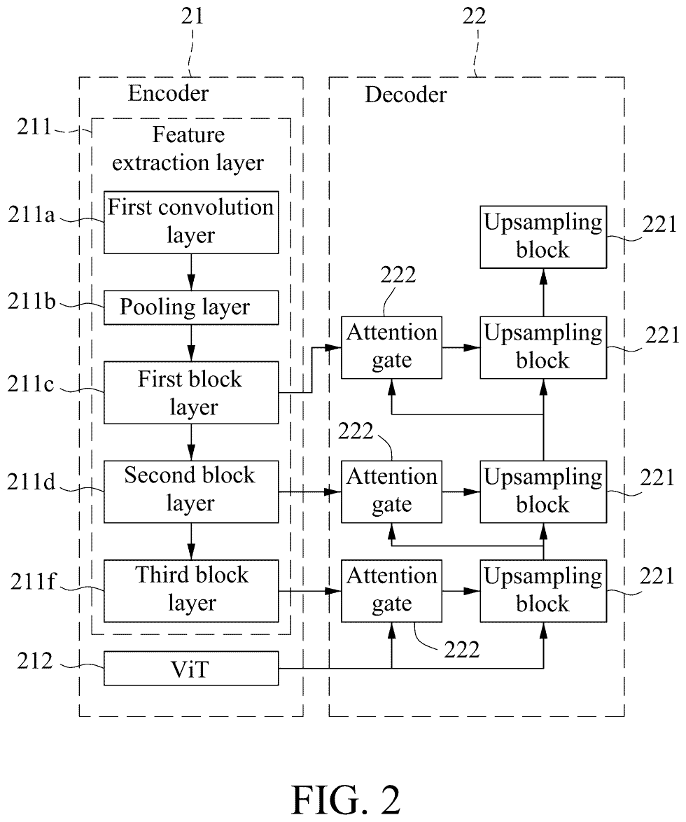

Referring to FIG. 2, the neural network model includes an encoder 21 and a decoder 22. The encoder 21 includes a feature extraction layer 211 and a vision transformer (ViT) 212. The feature extraction layer 211 of the encoder 21 includes a first convolution layer (211a), a pooling layer (211b), a first block layer (211c), a second block layer (211d) and a third block layer (211f). Each of the first block layer (211c), the second block layer (211d) and the third block layer (211f) includes plural blocks, and each of the blocks is composed of multiple convolution layers that are concatenated. The decoder 22 includes plural upsampling blocks 221 and plural attention gates 222. Each of the attention gates 222 corresponds to one of the upsampling blocks 221. It is worthy of note that in a variant embodiment, the attention gates 222 of the decoder 22 are omitted.

Specifically, a kernel size of the first convolution layer (211a) is 7×7, a number of channels of the first convolution layer (211a) is 64, and a stride length of the first convolution layer (211a) is 2. A kernel size of the pooling layer (211b) is 3×3, and a stride length of the pooling layer (211b) is 2. The decoder 22 includes four upsampling blocks 221.

The first block layer (211c) includes three blocks, and each of the three blocks is composed of three convolution layers that are concatenated. A kernel size of a first one of the three convolution layers is 1×1, a number of channels of the first one of the three convolution layers is 64, and a stride length of the first one of the three convolution layers is 1; a kernel size of a second one of the three convolution layers is 3×3, a number of channels of the second one of the three convolution layers is 64, and a stride length of the second one of the three convolution layers is 1; and a kernel size of a third one of the three convolution layers is 1×1, a number of channels of the third one of the three convolution layers is 256, and a stride length of the third one of the three convolution layers is 1.

The second block layer (211d) includes four blocks, and each of the four blocks is composed of three convolution layers that are concatenated. A kernel size of a first one of the three convolution layers is 1×1, a number of channels of the first one of the three convolution layers is 128, and a stride length of the first one of the three convolution layers is 2; a kernel size of a second one of the three convolution layers is 3×3, a number of channels of the second one of the three convolution layers is 128, and a stride length of the second one of the three convolution layers is 1; and a kernel size of a third one of the three convolution layers is 1×1, a number of channels of the third one of the three convolution layers is 512, and a stride length of the third one of the three convolution layers is 1.

The third block layer (211f) includes six blocks, and each of the six blocks is composed of three convolution layers that are concatenated. A kernel size of a first one of the three convolution layers is 1×1, a number of channels of the first one of the three convolution layers is 256, and a stride length of the first one of the three convolution layers is 2; a kernel size of a second one of the three convolution layers is 3×3, a number of channels of the second one of the three convolution layers is 256, and a stride length of the second one of the three convolution layers is 1; and a kernel size of a third one of the three convolution layers is 1×1, a number of channels of the third one of the three convolution layers is 1024, and a stride length of the third one of the three convolution layers is 1.

It is worth noting that in this embodiment, four times of downsampling are implemented respectively through the first convolution layer (211a), the first block layer (211c), the second block layer (211d) and the third block layer (211f), and thus four times of upsampling are implemented respectively through the four upsampling blocks 221 of the decoder 22, correspondingly. However, in other embodiments, a number of the upsampling blocks 221 of the decoder 22 may vary according to a number of times of downsampling implemented in the encoder 21, and is not limited to the disclosure herein.

A method of establishing a target model adapted to be used to identify a specific type of facial texture in a to-be-identified facial image according to the disclosure is implemented by the computing device 1 that was previously described. The method includes a data preparation procedure and a model-establishing procedure. It is worthy of note that in some embodiments, the data preparation procedure and the model-establishing procedure are respectively implemented by two separate computing devices, where one of the two separate computing devices includes the CPU 12 and implements the data preparation procedure, and the other of the two separate computing devices includes the GPU 13 and implements the model-establishing procedure.

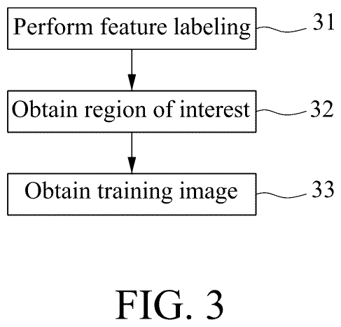

The computing device 1 further stores plural original facial images that are related respectively to the entries of training data. Each of the original facial images has the specific type of facial texture. Referring to FIG. 3, the data preparation procedure includes steps 31 to 33 delineated below.

In step 31, for each of the original facial images, the CPU 12 performs feature labeling on the original facial image to obtain a set of landmark points. In this embodiment, feature labeling is performed by using MediaPipe, which is an open-source framework developed by Google Research. In this embodiment, the set of landmark points includes 468 landmark points, but the disclosure is not limited thereto.

In step 32, for each of the original facial images, the CPU 12 obtains a region of interest of the original facial image according to a plurality of reference points that are selected from among the set of landmark points, where the region of interest has the specific type of facial texture. In this embodiment, the plurality of reference points are selected by a technician.

Specifically, for each of the original facial images, the plurality of reference points include a first reference point and a second reference point. The first reference point has coordinates (x₁, y₁) in a Cartesian coordinate system that has an x-axis defined based on columns of pixels of the original facial image, and a y-axis defined based on rows of pixels of the original facial image. The second reference point has coordinates (x₂, y₂) in the Cartesian coordinate system. The region of interest is a rectangle defined by the first reference point and the second reference point. For each pixel of the region of interest, the pixel has coordinates (xᵢ, yᵢ) in the Cartesian coordinate system, xᵢ ranges from min(x₁, x₂) to min(x₁, x₂)+|x₁−x₂|, and yᵢ ranges from min(y₁, y₂) to min(y₁, y₂)+|y₁−y₂|, where min(a, b) is a function that returns a minimum one of two values a and b.

In this embodiment, the specific type of facial texture is a nasolabial fold, the first reference point is a 135^{th} one of the 468 landmark points, and the second reference point is a 236^{th} one of the 468 landmark points, but the disclosure is not limited thereto.

In step 33, for each of the original facial images, the CPU 12 separates the region of interest from the original facial image to serve as the training image. Then, the CPU 12 stores the training image in the storage 11.

In particular, for each of the training images derived respectively from the original facial images, the CPU 12 would resize the training image such that the training image has a size of 224 pixels×384 pixels. Then, the technician creates a binary image for the training image thus resized. In the binary image, the technician assigns a value of zero to each pixel that is not related to the specific type of facial texture, and assigns a value of one to each pixel that is related to the specific type of facial texture. The binary image would serve as the ground truth image that is related to the training image, and pixels that are assigned with the value of one would cooperatively serve as the pre-labeled mark. The training image and the ground truth image that is related thereto are stored together in the storage 11 as one of the entries of training data.

It should be noted that in this embodiment, the CPU 12 further performs data augmentation on the training image and the ground truth image of each of the entries of training data. Particularly, for each of the entries of training data, the CPU 12 standardizes each of the training image and the ground truth image, randomly rotates each of the training image and the ground truth image, and designates the training image and the ground truth image thus rotated as a new entry of the training data.

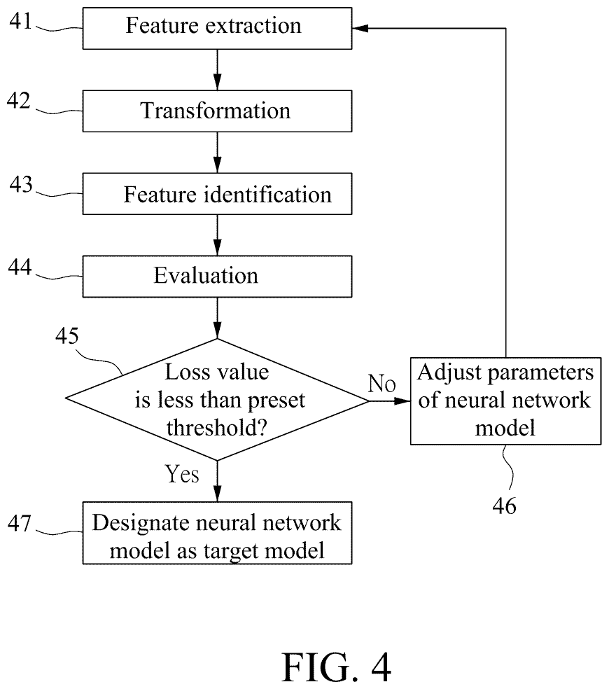

Referring to FIG. 4, the model-establishing procedure includes steps 41 to 47 delineated below.

In step 41, the GPU 13 uses the feature extraction layer 211 of the encoder 21 of the neural network model to perform feature extraction on the training images respectively of the entries of training data to obtain plural post-extraction images that correspond respectively to the entries of training data.

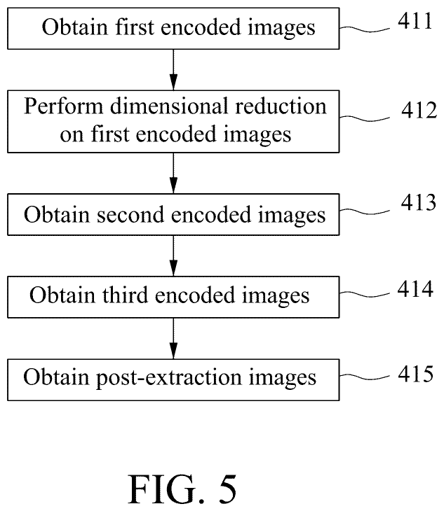

Specifically, step 41 includes sub-steps 411 to 415 as shown in FIG. 5 and delineated below.

In sub-step 411, the GPU 13 uses the first convolution layer (211a) of the feature extraction layer 211 to obtain plural first encoded images corresponding respectively to the entries of training data based on the training images respectively of the entries of training data. It is worthy of note that the first convolution layer (211a) is used to implement convolution operation. When a height, a width and a number of channels of one of the training images is expressed by a 3-tuple (H, W, 3), wherein H is a positive integer representing the height of the one of the training images, W is a positive integer representing the width of the one of the training images, and the last number 3 is the number of channels of the one of the training images, a height, a width and a number of channels of the corresponding one of the first encoded images would be expressed by a 3-tuple

$$( \frac{H}{2} , \frac{W}{2} , 64 ) .$$

In sub-step 412, the GPU 13 uses the pooling layer (211b) of the feature extraction layer 211 to perform dimensional reduction on the first encoded images. At this time, a height, a width and a number of channels of each of the first encoded images on which dimensional reduction has been performed would be expressed by a 3-tuple

$$( \frac{H}{4} , \frac{W}{4} , 64 ) .$$

After performing the dimensional reduction on the first encoded images, in sub-step 413, the GPU 13 uses the first block layer (211c) of the feature extraction layer 211 to obtain plural second encoded images corresponding respectively to the first encoded images based on the first encoded images. It is worthy of note that the first block layer (211c) is used to implement multiple times of convolution operation. A height, a width and a number of channels of each of the second encoded images would be expressed by a 3-tuple

$$( \frac{H}{4} , \frac{W}{4} , 256 ) .$$

In sub-step 414, the GPU 13 uses the second block layer (211d) of the feature extraction layer 211 to obtain plural third encoded images corresponding respectively to the second encoded images based on the second encoded images. It is worthy of note that the second block layer (211d) is used to implement multiple times of convolution operation. A height, a width and a number of channels of each of the third encoded images would be expressed by a 3-tuple

$$( \frac{H}{8} , \frac{W}{8} , 512 ) .$$

In sub-step 415, the GPU 13 uses the third block layer (211f) of the feature extraction layer 211 to obtain the post-extraction images respectively based on the third encoded images. It is worthy of note that the third block layer (211f) is used to implement multiple times of convolution operation. A height, a width and a number of channels of each of the post-extraction images would be expressed by a 3-tuple

$$( \frac{H}{16} , \frac{W}{16} , 1024 ) .$$

In step 42, the GPU 13 uses the VIT 212 of the encoder 21 of the neural network model to perform transformation on the post-extraction images to obtain plural post-transformation images that correspond respectively to the post-extraction images.

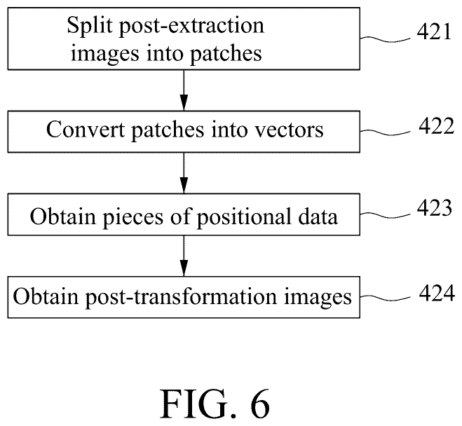

Specifically, for each of the post-extraction images, step 42 includes sub-steps 421 to 424 as shown in FIG. 6 and delineated below.

In sub-step 421, the GPU 13 splits the post-extraction image into plural patches each having a predetermined dimension.

In sub-step 422, for each of the patches, the GPU 13 converts the patch into a vector by using linear projection. For each of the vectors respectively converted from the patches, sub-steps 423 and 424 are executed.

In sub-step 423, the GPU 13 obtains a piece of positional data related to the vector by using position embedding.

In sub-step 424, the GPU 13 obtains the post-transformation image corresponding to the post-extraction image based on the piece of positional data and the vector.

In step 43, the GPU 13 uses the upsampling blocks 221 of the decoder 22 of the neural network model to perform feature identification on the post-transformation images to obtain plural post-identification images that correspond respectively to the post-transformation images. Each of the post-identification images has an identified mark indicating the specific type of facial texture.

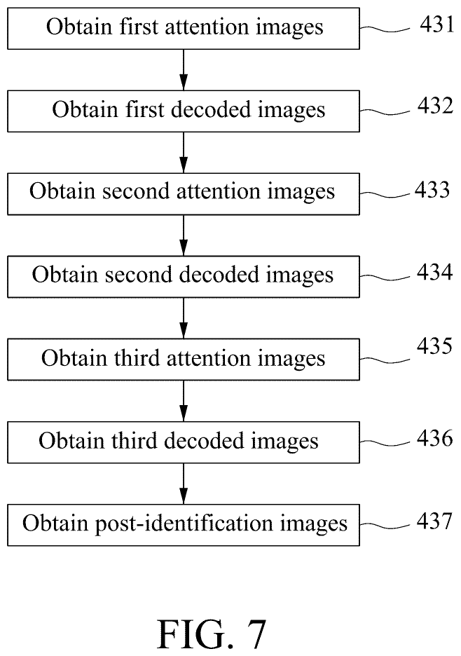

Specifically, step 43 includes sub-steps 431 to 437 as shown in FIG. 7 and delineated below.

In sub-step 431, the GPU 13 uses a first one of the attention gates 222 of the decoder 22 of the neural network model to obtain plural first attention images corresponding respectively to the post-transformation images based on the post-transformation images and the third encoded images.

In sub-step 432, the GPU 13 uses a first one of the upsampling blocks 221 of the decoder 22 of the neural network model to obtain plural first decoded images corresponding respectively to the post-transformation images based on the post-transformation images and the first attention images.

In particular, for each of the post-transformation images, the first one of the upsampling blocks 221 resizes the post-transformation image by doubling a height and a width of the post-transformation image and keeping a number of channels of the post-transformation image unchanged, and then merges the post-transformation image thus resized and the corresponding one of the first attention images to obtain a first merged image. For each of the first merged images derived respectively from the post-transformation images, a height, a width and a number of channels of the first merged image would be expressed by a 3-tuple

$$( \frac{H}{8} , \frac{W}{8} , 1536 ) .$$

Subsequently, for each of the first merged images, the first one of the upsampling blocks 221 passes the first merged image through two convolution layers of the first one of the upsampling blocks 221 to obtain the corresponding one of the first decoded images. Herein, a kernel size of each of the two convolution layers is 3×3, a number of channels of said each of the two convolution layers is 512, and a stride length of said each of the two convolution layers is 1. A height, a width and a number of channels of each of the first decoded images would be expressed by a 3-tuple

$$( \frac{H}{8} , \frac{W}{8} , 512 ) .$$

In sub-step 433, the GPU 13 uses a second one of the attention gates 222 of the decoder 22 of the neural network model to obtain plural second attention images corresponding respectively to the first decoded images based on the first decoded images and the second encoded images.

In sub-step 434, the GPU 13 uses a second one of the upsampling blocks 221 of the decoder 22 of the neural network model to obtain plural second decoded images corresponding respectively to the first decoded images based on the first decoded images and the second attention images.

In particular, for each of the first decoded images, the second one of the upsampling blocks 221 resizes the first decoded image by doubling a height and a width of the first decoded image and keeping a number of channels of the first decoded image unchanged, and then merges the first decoded image thus resized and the corresponding one of the second attention images to obtain a second merged image. For each of the second merged images derived respectively from the first decoded images, a height, a width and a number of channels of the second merged image would be expressed by a 3-tuple

$$( \frac{H}{4} , \frac{W}{4} , 768 ) .$$

Subsequently, for each of the second merged images, the second one of the upsampling blocks 221 passes the second merged image through two convolution layers of the second one of the upsampling blocks 221 to obtain the corresponding one of the second decoded images. Herein, a kernel size of each of the two convolution layers is 3×3, a number of channels of said each of the two convolution layers is 256, and a stride length of said each of the two convolution layers is 1. A height, a width and a number of channels of each of the second decoded images would be expressed by a 3-tuple

$$( \frac{H}{4} , \frac{W}{4} , 256 ) .$$

In sub-step 435, the GPU 13 uses a third one of the attention gates 222 of the decoder 22 of the neural network model to obtain plural third attention images corresponding respectively to the second decoded images based on the second decoded images and the first encoded images.

In sub-step 436, the GPU 13 uses a third one of the upsampling blocks 221 of the decoder 22 of the neural network model to obtain plural third decoded images corresponding respectively to the second decoded images based on the second decoded images and the third attention images.

In particular, for each of the second decoded images, the third one of the upsampling blocks 221 resizes the second decoded image by doubling a height and a width of the second decoded image and keeping a number of channels of the second decoded image unchanged, and then merges the second decoded image thus resized and the corresponding one of the third attention images to obtain a third merged image. For each of the third merged images derived respectively from the second decoded images, a height, a width and a number of channels of the third merged image would be expressed by a 3-tuple

$$( \frac{H}{2} , \frac{W}{2} , 320 ) .$$

Subsequently, for each of the third merged images, the third one of the upsampling blocks 221 passes the third merged image through two convolution layers of the third one of the upsampling blocks 221 to obtain the corresponding one of the third decoded images. Herein, a kernel size of each of the two convolution layers is 3×3, a number of channels of said each of the two convolution layers is 64, and a stride length of said each of the two convolution layers is 1. A height, a width and a number of channels of each of the third decoded images would be expressed by a 3-tuple

$$( \frac{H}{2} , \frac{W}{2} , 64 ) .$$

In sub-step 437, the GPU 13 uses a fourth one of the upsampling blocks 221 of the decoder 22 of the neural network model to obtain the post-identification images respectively based on the third decoded images.

In particular, for each of the third decoded images, the fourth one of the upsampling blocks 221 resizes the third decoded image by doubling a height and a width of the third decoded image and keeping a number of channels of the third decoded image unchanged, and then passes the third decoded image thus resized through two convolution layers of the fourth one of the upsampling blocks 221 to obtain the corresponding one of the post-identification images. Herein, a kernel size of each of the two convolution layers is 3×3, a number of channels of said each of the two convolution layers is 2, and a stride length of said each of the two convolution layers is 1. A height, a width and a number of channels of each of the post-identification images would be expressed by a 3-tuple (H, W, 2).

It is worth noting that a number of pixels related to the specific type of facial texture to be identified in an image usually occupies only 3% of a total number of pixels of the image, so, in a conventional approach of training a neural network model, a great amount of resources (including time, effort and so on) is frequently spent on processing pixels that are not related to the specific type of facial texture to be identified. In view of the aforesaid point, the attention gates 222 are used to emphasize the specific type of facial texture in the to-be-identified facial image during training of the neural network model, and thus accuracy of identifying the specific type of facial texture in the to be-identified facial image may be improved. In this way, efficiency of training the neural network model may be enhanced.

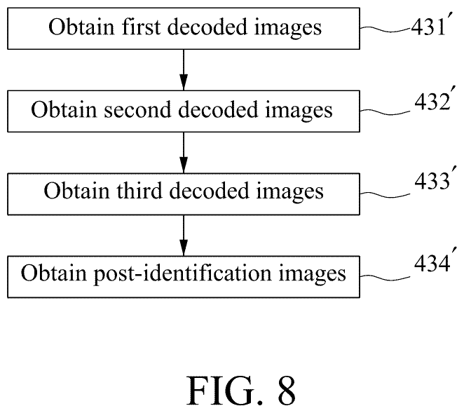

In the variant embodiment where the attention gates 222 of the decoder 22 are omitted, step 43 includes sub-steps 431′ to 434′ as shown in FIG. 8 and delineated below.

In sub-step 431′, the GPU 13 uses a first one of the upsampling blocks 221 of the decoder 22 of the neural network model to obtain plural first decoded images corresponding respectively to the post-transformation images based on the post-transformation images and the third encoded images.

In sub-step 432′, the GPU 13 uses a second one of the upsampling blocks 221 of the decoder 22 of the neural network model to obtain plural second decoded images corresponding respectively to the first decoded images based on the first decoded images and the second encoded images.

In sub-step 433′, the GPU 13 uses a third one of the upsampling blocks 221 of the decoder 22 of the neural network model to obtain plural third decoded images corresponding respectively to the second decoded images based on the second decoded images and the first encoded images.

In sub-step 434′, the GPU 13 uses a fourth one of the upsampling blocks 221 of the decoder 22 of the neural network model to obtain the post-identification images respectively based on the third decoded images.

In step 44, the GPU 13 uses an algorithm of loss function to perform evaluation based on the post-identification images and the ground truth images respectively of the entries of training data to obtain a loss value.

The loss value is the Dice loss that is expressed as:

$$Dice loss = 1 - \frac{2 \vert X ⋂ Y \vert}{\vert X \vert + \vert Y \vert + ε} ,$$

where 0<ε<<1, X represents a set of pixels that make up the identified mark indicating the specific type of facial texture in the post-identification images, and Y represents a set of pixels that make up the pre-labeled mark indicating the specific type of facial texture in the ground truth images. It should be noted that a very small positive number ε is used to prevent errors due to division by zero.

In one embodiment, for each of the post-identification images, the GPU 13 further creates a binary image from the post-identification image, wherein a height, a width and a number of channels of the binary image is expressed by a 3-tuple (H, W, 1). For each of plural pixels in the binary image (hereinafter also referred to as the binary pixel), the binary pixel is assigned with a value according to two values respectively of two pixels (hereinafter also referred to as the reference pixels), at a corresponding position (i.e., at an equivalent position), respectively in two channels of the post-identification image. More specifically, in a scenario where the post-identification image has a channel zero and a channel one, the binary pixel will be assigned with a value of zero when a value of one of the reference pixels that is in the channel zero is not less than a value of another of the reference pixels that is in the channel one, and will be assigned with a value of one when a value of the one of the reference pixels that is in the channel zero is less than a value of the another of the reference pixels that is in the channel one. It should be noted that a pixel in the binary image will be assigned with the value of one for indicating that the pixel is related to the specific type of facial texture, and will be assigned with the value of zero for indicating that the pixel is not related to the specific type of facial texture. Thereafter, the GPU 13 uses the algorithm of loss function to perform evaluation based on the binary images created respectively from the post-identification images and the ground truth images respectively of the entries of training data to obtain the loss value.

In step 45, the GPU 13 determines whether the loss value is less than a preset threshold. In response to determining that the loss value is not less than the preset threshold, a procedure flow of the method proceeds to step 46. On the other hand, in response to determining that the loss value is less than the preset threshold, the procedure flow proceeds to step 47.

In step 46, the GPU 13 adjusts plural parameters of the neural network model, and repeats steps 41 to 45 by using the neural network model, the parameters of which have been adjusted.

In step 47, the GPU 13 designates the neural network model as the target model.

To sum up, for the method of establishing a target model adapted to be used to identify a specific type of facial texture in a to-be-identified facial image according to the disclosure, the GPU 13 uses the feature extraction layer 211 to perform feature extraction on the training images to obtain the post-extraction images, uses the VIT 212 to perform transformation on the post-extraction images to obtain the post-transformation images (accuracy of detection of a type of facial texture that are large or wide may be improved in this way), and uses the upsampling blocks 221 to perform feature identification on the post-transformation images to obtain the post-identification images. Moreover, the attention gates 222 are used to emphasize the specific type of facial texture in the to-be-identified facial image, and thus efficiency of training a neural network model to obtain the target model may be enhanced. Compared with conventional approaches to identifying a type of facial texture, the method according to the disclosure may reduce efforts spent on complicated parameter tuning and may avoid costs of high-precision hardware (e.g., three-dimensional scanners).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of establishing a target model adapted to be used to identify a specific type of facial texture in a to-be-identified facial image, the method to be implemented by a computing device that stores plural entries of training data and a neural network model, each of the entries of training data including a training image that has the specific type of facial texture, and a ground truth image that is related to the training image and that has a pre-labeled mark indicating the specific type of facial texture, the neural network model including an encoder and a decoder, the encoder including a feature extraction layer and a vision transformer (ViT), the decoder including plural upsampling blocks, the method comprising steps of:
A) using the feature extraction layer of the encoder of the neural network model to perform feature extraction on the training images respectively of the entries of training data to obtain plural post-extraction images that correspond respectively to the entries of training data;
B) using the ViT of the encoder of the neural network model to perform transformation on the post-extraction images to obtain plural post-transformation images that correspond respectively to the post-extraction images;
C) using the upsampling blocks of the decoder of the neural network model to perform feature identification on the post-transformation images to obtain plural post-identification images that correspond respectively to the post-transformation images, each of the post-identification images having an identified mark indicating the specific type of facial texture;
D) using an algorithm of loss function to perform evaluation based on the post-identification images and the ground truth images respectively of the entries of training data to obtain a loss value;
E) determining whether the loss value is less than a preset threshold;
F) in response to determining that the loss value is not less than the preset threshold, adjusting plural parameters of the neural network model, and repeating steps A) to E) by using the neural network model, the parameters of which have been adjusted; and
G) in response to determining that the loss value is less than the preset threshold, designating the neural network model as the target model.

2. The method as claimed in claim 1, the computing device further storing plural original facial images that are related respectively to the entries of training data, each of the original facial images having the specific type of facial texture, the method further comprising, prior to step A), steps of, for each of the original facial images:
performing feature labeling on the original facial image to obtain a set of landmark points;
obtaining a region of interest of the original facial image according to a plurality of reference points that are selected from among the set of landmark points, where the region of interest has the specific type of facial texture; and
separating the region of interest from the original facial image to serve as the training image.

3. The method as claimed in claim 2, wherein for each of the original facial images:
the plurality of reference points include a first reference point and a second reference point, the first reference point having coordinates (x₁, y₁) in a Cartesian coordinate system that has an x-axis defined based on columns of pixels of the original facial image, and a y-axis defined based on rows of pixels of the original facial image, the second reference point having coordinates (x₂, y₂) in the Cartesian coordinate system;
the region of interest is a rectangle defined by the first reference point and the second reference point; and
for each pixel of the region of interest, the pixel has coordinates (xᵢ, yᵢ) in the Cartesian coordinate system, xᵢ ranges from min(x₁, x₂) to min(x₁, x₂)+|x₁−x₂|, and yᵢ ranges from min(y₁, y₂) to min(y₁, y₂)+|y₁−y₂|, where min(a, b) is a function that returns a minimum one of two values a and b.

4. The method as claimed in claim 2, wherein feature labeling is performed by using MediaPipe.

5. The method as claimed in claim 1, the feature extraction layer of the encoder including a first convolution layer, a pooling layer, a first block layer, a second block layer and a third block layer, each of the first block layer, the second block layer and the third block layer including plural blocks each being composed of multiple convolution layers that are concatenated,
wherein step A) includes sub-steps of
using the first convolution layer of the feature extraction layer to obtain, based on the training images respectively of the entries of training data, plural first encoded images corresponding respectively to the entries of training data,
using the pooling layer of the feature extraction layer to perform dimensional reduction on the first encoded images,
after performing the dimensional reduction on the first encoded images, using the first block layer of the feature extraction layer to obtain, based on the first encoded images, plural second encoded images corresponding respectively to the first encoded images,
using the second block layer of the feature extraction layer to obtain, based on the second encoded images, plural third encoded images corresponding respectively to the second encoded images, and
using the third block layer of the feature extraction layer to obtain the post-extraction images respectively based on the third encoded images.

6. The method as claimed in claim 5, wherein step C) includes sub-steps of:
using a first one of the upsampling blocks of the decoder of the neural network model to obtain, based on the post-transformation images and the third encoded images, plural first decoded images corresponding respectively to the post-transformation images;
using a second one of the upsampling blocks of the decoder of the neural network model to obtain, based on the first decoded images and the second encoded images, plural second decoded images corresponding respectively to the first decoded images;
using a third one of the upsampling blocks of the decoder of the neural network model to obtain, based on the second decoded images and the first encoded images, plural third decoded images corresponding respectively to the second decoded images; and
using a fourth one of the upsampling blocks of the decoder of the neural network model to obtain the post-identification images respectively based on the third decoded images.

7. The method as claimed in claim 5, the decoder further including plural attention gates, each of the attention gates corresponding to one of the upsampling blocks,
wherein step C) includes sub-steps of
using a first one of the attention gates of the decoder of the neural network model to obtain, based on the post-transformation images and the third encoded images, plural first attention images corresponding respectively to the post-transformation images,
using a first one of the upsampling blocks of the decoder of the neural network model to obtain, based on the post-transformation images and the first attention images, plural first decoded images corresponding respectively to the post-transformation images,
using a second one of the attention gates of the decoder of the neural network model to obtain, based on the first decoded images and the second encoded images, plural second attention images corresponding respectively to the first decoded images,
using a second one of the upsampling blocks of the decoder of the neural network model to obtain, based on the first decoded images and the second attention images, plural second decoded images corresponding respectively to the first decoded images,
using a third one of the attention gates of the decoder of the neural network model to obtain, based on the second decoded images and the first encoded images, plural third attention images corresponding respectively to the second decoded images,
using a third one of the upsampling blocks of the decoder of the neural network model to obtain, based on the second decoded images and the third attention images, plural third decoded images corresponding respectively to the second decoded images, and
using a fourth one of the upsampling blocks of the decoder of the neural network model to obtain the post-identification images respectively based on the third decoded images.

8. The method as claimed in claim 1, wherein step B) includes sub-steps of, for each of the post-extraction images:
splitting the post-extraction image into plural patches each having a predetermined dimension;
for each of the patches, converting the patch into a vector by using linear projection; and
for each of the vectors respectively converted from the patches,
obtaining a piece of positional data related to the vector by using position embedding, and
obtaining the post-transformation image corresponding to the post-extraction image based on the piece of positional data and the vector.

9. The method as claimed in claim 1, wherein the loss value is the Dice loss that is expressed as:
$$Dice loss = 1 - \frac{2 \vert X ⋂ Y \vert}{\vert X \vert + \vert Y \vert + ε} ,$$
where 0<ε<<1, X represents a set of pixels that make up the identified mark indicating the specific type of facial texture in the post-identification images, and Y represents a set of pixels that make up the pre-labeled mark indicating the specific type of facial texture in the ground truth images.
